(19) United States
(12) Patent Application Publication
(10) Pub. No.: US 2007/0071219 A1
(43) Pub. Date: Mar. 29, 2007

(54) Method for improving control capability of service control point during a call

(75) Inventors: Xiaojing Wu, Shenzhen (CN); Wenxin Xia, Shenzhen (CN)

Correspondence Address: FULBRIGHT & JAWORSKI L.L.P., 600 CONGRESS AVE., SUITE 2400, AUSTIN, TX, 78701, US

(73) Assignee: HUAWEI TECHNOLOGIES CO., LTD.

(21) Appl. No.: 11/477,141

(22) Filed: Jun. 28, 2006

(30) Foreign Application Priority Data
Jun. 28, 2005 (CN) 200510080063.3

(51) Int. Cl. H04M 7/00

(52) U.S. Cl. 379/221.09

(57) ABSTRACT

The present invention discloses a method for improving the control capability of the Service Control Point (SCP) during a call to resolve the problem in the prior art that the SCP can not gain control for calling. The method comprises the steps of configuring a virtual Detection Point (DP) event by a SCP, and specifying a condition at which a Service Switch Point (SSP) reports the virtual DP event; monitoring a call by the SSP, and reporting the virtual DP event to the SCP when the condition of the virtual DP event is met; exchanging signaling by the SCP with the SSP to perform call control on receiving the report.

This application claims benefit of priority to Chinese Patent Application No.: 200510080063.3, filed Jun. 28, 2005. The entire contents of which are incorporated by reference.

### FIELD OF THE INVENTION

The present invention relates to the communication field, and more particularly, to a method for improving control capability of the Service Control Point (SCP) during a call.

### BACKGROUND OF THE INVENTION

In the existing intelligent network services, a Service Control Point (SCP), through intelligent network protocols, such as INAP, CAP, WIN protocol, performs signaling exchange with a Service Switch Point (SSP) to accomplish flexible call control and provide fast, diverse services. However, when a user initiates a call, it is the SSP that has the control for calling. The SCP will gain the control for calling only when the SSP detects that the call transits from one state to another and reports the related Detection Point (DP) events. Therefore, under the present protocol(s), a SCP lacks the capability for call control during the communication or under a certain calling state, for example, it is impossible to implement the functions of, for example, presenting prompt information to the user, requesting for the user's acknowledgment during the communication, and the like. As a result, it is difficult to achieve the diversity of services.

### SUMMARY OF THE INVENTION

In one aspect, the present invention provides a method for improving control capability of a Service Control Point (SCP) during a call. The method comprises the steps of:

configuring a virtual Detection Point (DP) event by a SCP, and specifying a condition at which a Service Switch Point (SSP) reports the virtual DP event;

monitoring a call by the SSP, and reporting the virtual DP event to the SCP when the condition of the virtual DP event is met;

exchanging signaling by the SCP with the SSP to perform call control on receiving the report.

Alternatively, the step of configuring a virtual DP event by a SCP comprises the steps of:

delivering a Request Report BCSM Event operation message by the SCP to the SSP, in which service type and time parameters are carried; or

delivering a newly appointed message by the SCP to the SSP, in which service type and time parameters are carried.

Alternatively, the step of monitoring a call by the SSP and reporting the virtual DP event to the SCP when the condition of the virtual DP event is met includes the steps of:

monitoring the call by the SSP, and reporting the virtual DP event to the SCP when the call meets the condition that the parameters of the service type and time carried in the Request Report BCSM Event operation message.

Preferably, the SSP reporting the virtual DP event to the SCP comprises:

reporting the virtual DP event either at a specific time after a call starts, or

repeatedly reporting the virtual DP event at specific time intervals after the call starts.

Said call control comprises the operations of tone-playing, number-receiving and charging.

Preferably, the call is not interrupted during the step of exchanging signaling by the SCP with the SSP to perform call control.

In the present invention, the SCP may perform configuration of the DP event reporting by using the existing DP event reporting mechanism according to the requirement of the service, which improves the control capacity of the SCP during a call. The SCP may flexibly configure the DP reporting time during the calling process, so as to achieve the functions of tone-playing, number-receiving and charging, etc.

### BRIEF DESCRIPTION OF THE DRAWINGS

FIG. 1 is a schematic flow chart of the prior art;

FIG. 2 is a schematic flow chart according to an embodiment of the present invention.

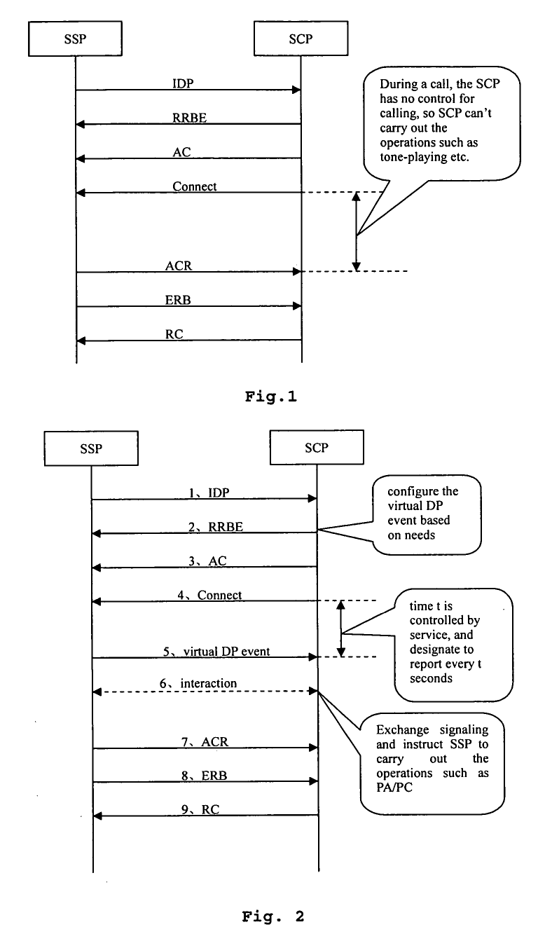

### DETAILED DESCRIPTION OF THE PREFERRED EMBODIMENTS

To improve the control capability of a Service Control Point (SCP) during a call, in an embodiment of the present invention, a virtual DP event is configured in a Service Switch Point (SSP) according to the requirement of the service, and the condition under which the SSP reports the virtual DP event (s) is designated. This condition can be a time-related condition, for example, the SSP is designated to report the DP event(s) at “a specific time”. This specific time can be n seconds after the call starts, or every n seconds after the call starts. Also, this time-related condition can be: reporting the virtual event(s) n seconds after a certain event occurs, or reporting the virtual event(s) every n seconds after a certain event occurs, in which n is designated according to the requirement of the service. For example, The SCP can specify that both of the calling and called parties report the virtual event (s) 10 seconds after the communication starts.

The SSP monitors the call and reports the virtual DP event(s), after the virtual DP event(s) has been configured. The SCP can perform signaling exchange with the SSP on receiving the virtual DP event(s), to accomplish the functions of tone-playing, number-receiving and charging, so as to provide more value-added services.

The reporting of a virtual DP event according to an embodiment of the present invention is the same as that of an existing DP event in that: the call processing is suspended by event reporting so that the SCP may have an influence on the subsequent call processing. However, in the embodiment of the present invention, the SCP can configure the reporting conditions flexibly according to the requirement of the service, i.e., the condition about reporting time is different from that of the DP event in the prior art, hence it is called a virtual DP event. The event is reported by controlling the SSP according to the requirement of the service, such that the SCP gain the control for calling.

In the present invention, the configuration of virtual DP event by the SCP is accomplished by utilizing an existing protocol, or engaging a new protocol between the SSP and the SCP. In the embodiment of the present invention, it is accomplished by utilizing and expanding the Request Report BCSM Event (RRBE) message of requesting to report a BCSM event in the INAP protocol.

The RRBE operation in the prior art is delivered by the SCP to the SSP, to request the SSP to configure a Detection Point dynamically. In the regime of intelligent networks, for all the calls, the SSP divides each of them into relatively stable states one after another, and the calls will be transited among these states. The detection point is a transiting point at which a call is transited from one state to another. Configuring the detection point dynamically, is equivalent to that the SCP notifies the SSP and reports the call event to the SCP when a call is transited from one state to another. The SSP monitors the call state, and reports to the SCP when a change in the call state occurs.

The particular parameters of the existing RRBE operation include the numbers of the relevant Detection Points and the reporting conditions of the Detection Points and the like, such as, DP4 (the condition is that route detection fails), DP5 (the condition is that the called party is busy), DP6 (the condition is that no response from the called party for a long time), DP9 (the condition is that the calling or called party hangs up), DP10 (the condition is that the calling party releases prematurely). The SCP delivers a RRBE operation to the SSP, requesting the SSP to configure the DP events based on the related parameters. The SSP will report to the SCP when these events occur.

In one embodiment, in an example with time as the condition for reporting a virtual DP event, the particular parameters of RRBE operation, including the service type and the time parameter n seconds, are expanded, wherein the service type indicates the time type for reporting a virtual DP event. For example, if the service type is set to 1, it means to report n seconds after a call starts; if the service type is 2, it means to report every n seconds after a call starts. According to the requirement of the service, the SCP accomplishes the configuration of the virtual DP event(s) by filling the value of the service type parameter and the value of the time parameter in the RRBE operation.

As illustrated in FIG. 2, a particular flow, in which the SCP controls the calling by the configuration of the virtual DP event(s) during a call, is described as the following:

Step 1, The SSP triggers an intelligence service, reports an Initial Detection Point (IDP) to the SCP and requests the SCP intelligent calling to establish a one-time control relation; in which the parameters of this operation message includes the service key, the calling number and the called number;

Step 2, The SCP configures the virtual DP event(s) based on the requirement of the service, and delivers a RRBE operation message to the SSP. This operation message carries the service type parameter and the time parameter which are configured based on the requirement of the service;

Step 3, The SCP delivers an Apply Charging (AC) request to the SSP, notifying the SSP to be ready for charging. This request contains the charging party, as well as other information about charging;

Step 4, The SCP delivers an establish connect operation to the SSP, instructing the SSP to establish a call connect;

Step 5, During the calling process, the SSP monitors the call depending on the parameters carried in the RRBE operation message delivered by the SCP, and reports the virtual DP event(s) when the condition for the virtual DP event(s) is satisfied; for example, in the case that the service type parameter is 1 and the time parameter is 20 seconds, the SSP monitors the calling time after the call begins, and reports the virtual DP event(s) when the time reaches 20 seconds;

Step 6, On receiving the report of the virtual DP event(s), the SCP performs interaction according to the requirement of the service, instructing the SSP to perform the operation of only tone-playing but no number-receiving, or the operation of both tone-playing and number-receiving;

Step 7, The SSP sends an Apply Charging Report (ACR) message to the SCP, in which the parameters included in the ACR comprises the starting time, the terminating time, the calling party, the called party and the charging party of the call, etc;

Step 8, The SSP reports an Event Report BCSM (ERB) to the SCP, to report the call event, in other words, to report to the SCP that the user hangs up;

Step 9, The SCP returns a Release Call (RC) operation to the SSP, notifying the SSP to release the resources, thus the call is disconnected.

According to the embodiments of the present invention, the Service Control Point may gain the control for calling at a certain time after a call starts according to the requirement of the service, and instruct the SSP to carry out the related operations.

The Virtual DP events can be configured flexibly according to the requirement of the service. The service may specify whether to report the virtual DP event(s), may specify that the virtual DP event(s) should be reported at a certain time after the call starts, or may specify that the virtual DP event(s) should be reported repeatedly after the call has started for a certain time, etc.

On receiving the virtual DP event (s), the SCP instructs the SSP to carry out the operations such as, tone-playing, number-receiving and charging-adjustment during the call. The talk of the users will not be interrupted during the related operations.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

While the present invention has been illustrated and described with reference to some preferred embodiments of the present invention, it will be apparent to those skilled in the art that various variations and modifications can be made without departing from the spirit and scope of the present invention, and these variations and modifications is intended to be covered by the present invention provided that they are within the spirit and scope of the accompanying claims and their equivalents.

1. A method for improving control capability of a Service Control Point (SCP) during a call, comprising the steps of:
configuring a virtual Detection Point (DP) event by a SCP, and specifying a condition at which a Service Switch Point (SSP) reports the virtual DP event;
monitoring a call by the SSP, and reporting the virtual DP event to the SCP when the condition of the virtual DP event is met;
exchanging signaling by the SCP with the SSP to perform call control on receiving the report.

2. The method as claimed in claim 1, wherein configuring a virtual DP event by a SCP comprises the steps of:
delivering a Request Report BCSM Event operation message by the SCP to the SSP, in which service type and time parameters are carried; or
delivering a newly appointed message by the SCP to the SSP, in which service type and time parameters are carried.

3. The method as claimed in claim 2, wherein the step of monitoring a call by the SSP, and reporting the virtual DP event to the SCP when the condition of the virtual DP event is met includes the steps of:
monitoring the call by the SSP, and reporting the virtual DP event to the SCP when the call meets the condition that the parameters of the service type and time carried in the Request Report BCSM Event operation message.

4. The method as claimed in claim 1, wherein the SSP reporting the virtual DP event to the SCP comprises:
reporting the virtual DP event either at a specific time after a call starts, or
repeatedly reporting the virtual DP event at specific time intervals after a call starts.

5. The method as claimed in claim 1, wherein said call control comprises:
the operations of tone-playing, number-receiving and charging.

6. The method as claimed in claim 1, wherein during the step of exchanging signaling by the SCP with the SSP to perform call control, the call is not interrupted.
